(19) United States
(12) Patent Application Publication
(10) Pub. No.: US 2010/0240409 A1
(43) Pub. Date: Sep. 23, 2010

(54) WIRELESS COMMUNICATION SYSTEM, WIRELESS BASE STATION, WIRELESS TERMINAL STATION, AND TRANSMISSION POWER CONTROL METHOD USING THE SAME

(76) Inventor: Shinya Muraoka, Tokyo (JP)

Correspondence Address: Mr. Jackson Chen, 6535 N. STATE HWY 161, IRVING, TX, 75039, US

(21) Appl. No.: 12/159,569

(22) PCT Filed: Oct. 26, 2006
(86) PCT No.: PCT/JP2006/321321

§ 371 Date: Jun. 27, 2008

(30) Foreign Application Priority Data
Jan. 4, 2006 (JP) 2006-000116

(51) Int. Cl. H04B 7/00

(52) U.S. Cl. 455/522

(57) ABSTRACT

Transmission rate detector (211) detects a transmission rate of uplink data to be transmitted to a wireless base station, compares the detected transmission rate with a preset transmission rate threshold, and outputs the comparison result to transmission power control step generator (212). Based on transmission power control information transmitted from the wireless base station and separated in separator (202) and on the comparison result output from transmission rate detector (211), transmission power control step generator (212) changes the transmission power variation range for controlling the transmission power.

### TECHNICAL FIELD

The present invention relates to a wireless communication system, wireless base station, and wireless terminal station using W-CDMA techniques, and a transmission power control method using the system and stations.

### BACKGROUND ART

In the W-CDMA communication system that is rapidly becoming widespread in recent years, issues to be addressed include solving the near-far problem, compensating for received-signal attenuation due to fading, and securing the communication quality of services. To resolve these issues, closed-loop transmission power control is performed between a wireless base station and a wireless terminal station. This closed-loop transmission power control is performed using the value of SIR (Signal-to-Interference Ratio), which is the ratio of the reception power to the interference signal power. Specifically, a Signal-to-Interference Ratio (hereinafter referred to as a Target SIR) that enables obtaining the communication quality of services is preset. The Target SIR is compared with the Reception Signal-to-Interference Ratio (hereinafter referred to as a Reception SIR) of a signal transmitted from the other station and received via a wireless communication. If the comparison indicates that the Reception SIR is larger than the Target SIR, a command (hereinafter referred to as a TPC Command) instructing the other station to decrease the transmission power is generated. If the Reception SIR is smaller than the Target SIR, a TPC Command instructing the other station to increase the transmission power is generated. The generated TPC Command is then transmitted to the other station. In the other station that received the TPC Command, the transmission power is controlled based on the TPC Command.

FIG. 1 is a diagram showing an exemplary configuration of a conventional wireless base station, and FIG. 2 is a diagram showing the format of a signal received at the conventional wireless base station shown in FIG. 1.

The wireless base station shown in FIG. 1 is provided with receiver 1001, separator 1002, SIR estimator 1003, SIR comparator 1004, multiplexer 1007, transmitter 1008, encoder 1009, and decoder 1010. As shown in FIG. 2, the signal received at the wireless base station shown in FIG. 1 includes a Pilot signal, user data, and a TPC Command.

Receiver 1001 demodulates received signal RD101 received at the wireless base station into a digital signal in a predetermined scheme and outputs demodulated signal RD102 to separator 1002. Separator 1002 separates input signal RD102 into user data, a Pilot signal, and a TPC Command and outputs them as RD103, RD104, and RD105, respectively. SIR estimator 1003 estimates a Reception SIR from input RD104 and outputs the estimated Reception SIR as SIR101 to SIR comparator 1004. SIR comparator 1004 receives input of SIR101 output from SIR estimator 1003, compares input SIR101 with a preset Target SIR, and outputs a comparison result as TPC102 to multiplexer 1007. This signal TPC102, that is the comparison result, will be a TPC Command instructing a wireless terminal station connected to this wireless base station to decrease or increase the transmission power. Decoder 1010 demodulates RD103, i.e., the user data, of the received signal in a predetermined scheme and transmits the demodulated signal as RD106 to an external data apparatus (not shown). Encoder 1009 receives TD104, which is uplink data transmitted from an external data apparatus, encodes TD104 in a predetermined scheme, and outputs it as TD103 to multiplexer 1007. Multiplexer 1007 receives input of TPC102 output from SIR comparator 1004 and TD103 output from Encoder 1009, multiplexes input TPC102 and TD103 into the format shown in FIG. 2, and outputs the multiplexed signal as TD102 to transmitter 1008. Transmitter 1008 converts TD102 output from multiplexer 1007 into wireless signal TD101 in a predetermined scheme and transmits the wireless signal.

The wireless terminal station connected to the wireless base station shown in FIG. 1 is also the same in configuration as the wireless base station shown in FIG. 1. RD105 output from separator 1002 is input to transmitter 1008, so that the transmission power for uplink data to be transmitted from the wireless terminal station to the wireless base station is controlled based on RD105.

In this manner, the transmission power for a signal to be transmitted is controlled based on the result of comparison between the Reception SIR value and the Target SIR (for example, see Japanese Patent Laid-Open No. 2004-200824).

However, the above-described transmission power control has the following problems.

In the W-CDMA communication system, wireless signals transmitted and received at other wireless terminal stations become interference signals for wireless signals transmitted and received at any wireless terminal station. For example, increasing the transmission power for uplink signals according to the TPC Command in one wireless terminal station A means an increase in the interference power for another wireless terminal station B. Therefore, wireless terminal station B is requested to increase the uplink transmission power for the wireless base station in order to improve the Reception SIR.

However, this causes an increase in interference power for wireless terminal station A, and wireless terminal station A is requested to further increase the transmission power for uplink signals. Thus, there is the following problem. Wireless terminal station A and the wireless terminal station B are repeatedly requested to increase their transmission power, so that their transmission power tends to be infinitely increased. Finally, this leads to an increase in the amount of interference in the entire cell.

Another problem is that this introduces a decrease in the cell capacity because the capacity (the maximum number of wireless terminal stations capable of communication) of each cell in the W-CDMA communication depends on the interference power.

There is a further problem. When one wireless terminal station rapidly increases the uplink transmission power because of the influence of the reception environment, other wireless terminal stations correspondingly increase their uplink transmission power as described above. As a result, the amount of interference power in the entire cell rapidly increases. This causes not only a decreased cell capacity but also a degraded communication quality or a communication shutdown for users in communication.

### DISCLOSURE OF THE INVENTION

To solve the above problems, it is an object of the present invention to provide a wireless communication system, a wireless base station, and a wireless terminal station capable of minimizing the amount of interference for other users and the entire cell, and a transmission power control method using the system and stations.

To achieve the above object, according to the present invention,

in a wireless communication system including a wireless base station and a wireless terminal station that transmit a signal to the wireless base station, the wireless terminal station controls transmission power for signal transmission to the wireless base station, the wireless communication system is characterized in that

the wireless base station estimates a fading frequency of a signal transmitted and received from the wireless terminal station, compares the estimated fading frequency with a preset frequency threshold, and transmits a comparison result to the wireless terminal station, and

the wireless terminal station receives the comparison result, detects the transmission rate of uplink data to be transmitted to the wireless base station, compares the transmission rate with a preset transmission rate threshold, and, based on the comparison result thereof and the comparison result transmitted from the wireless base station, changes the transmission power variation range for controlling the transmission power.

The wireless communication system is characterized in that

the wireless base station includes frequency estimation means for estimating the fading frequency of the signal transmitted and received from the wireless terminal station and comparing the estimated fading frequency with the preset frequency threshold, and

the wireless terminal station includes:

transmission rate detection means for detecting the transmission rate of the uplink data to be transmitted to the wireless base station and comparing the transmission rate with the preset transmission rate threshold; and

transmission power control step generation means for changing, based on the comparison result in the transmission rate detection means and the comparison result in the frequency estimation means, the transmission power variation range for controlling the transmission power.

The wireless communication system is characterized in that

if the transmission rate is larger than the transmission rate threshold and if the comparison result in the frequency estimation means indicates that the fading frequency is smaller than the frequency threshold, the transmission power control step generation means increases the transmission power variation range for controlling the transmission power.

A wireless base station is connected to a wireless terminal station, wherein

the wireless base station estimates the fading frequency of a signal transmitted and received from the wireless terminal station, compares the estimated fading frequency with a preset frequency threshold, and transmits the comparison result to the wireless terminal station.

A wireless terminal station is connected to a wireless base station, receives transmission power control information transmitted from the wireless base station, and, based on the received transmission power control information, controls transmission power for signal transmission to the wireless base station, wherein

the wireless terminal station detects the transmission rate of uplink data to be transmitted to the wireless base station, compares the transmission rate with a preset transmission rate threshold, and, based on the comparison result and the transmission power control information, changes the transmission power variation range for controlling the transmission power.

The wireless terminal station is characterized by including:

transmission rate detection means for comparing the transmission rate of the uplink data to be transmitted to the wireless base station with the preset transmission rate threshold; and

transmission power control step generation means for changing, based on the comparison result in the transmission rate detection means and the transmission power control information, the transmission power variation range for controlling the transmission power.

In a wireless communication system including a wireless base station and a wireless terminal station that transmits a signal to the wireless base station, the wireless terminal station controls transmission power for signal transmission to the wireless base station, a transmission power control method includes:

the wireless base station estimating the fading frequency of a signal transmitted and received from the wireless terminal station;

the wireless base station comparing the estimated fading frequency with a preset frequency threshold;

the wireless base station transmitting a comparison result to the wireless terminal station;

the wireless terminal station detecting the transmission rate of uplink data to be transmitted to the wireless base station;

the wireless terminal station comparing the transmission rate with the preset transmission rate threshold; and

the wireless terminal station changing, based on a comparison result thereof and the comparison result transmitted from the wireless base station, a transmission power variation range for controlling the transmission power.

The transmission power control method is characterized by including

increasing the transmission power variation range for controlling the transmission power if the transmission rate is larger than the transmission rate threshold and if the fading frequency is smaller than the frequency threshold.

In the present invention configured as above, the wireless base station estimates the fading frequency of a signal transmitted from the wireless terminal station and received, compares the estimated fading frequency with a preset frequency threshold, and transmits the comparison result to the wireless terminal station that controls transmission power for signal transmission to the wireless base station, and the wireless terminal station receives the comparison result, detects the transmission rate of uplink data to be transmitted to the wireless base station, compares the transmission rate with a preset transmission rate threshold, and, based on the comparison result thereof and the comparison result transmitted from the wireless base station, changes the transmission power variation range for controlling the transmission power.

In this manner, the transmission power variation range for controlling the uplink transmission power can be changed based on the fading frequency of the signal transmitted from the wireless terminal station and received at the wireless base station, and based on the transmission rate of external data that is input to the wireless terminal station. Therefore, the transmission power variation range can be increased only for the cases such as where the fading frequency of the uplink signal is a frequency that allows compensation for the amount of attenuation of the uplink signal, or where data communication is for significant data performed at a fast rate. This can minimize interference with other users.

As described above, the present invention is configured in such a manner that the wireless base station estimates the fading frequency of a signal transmitted from the wireless terminal station and received, compares the estimated fading frequency with a preset frequency threshold, and transmits the comparison result to the wireless terminal station that controls transmission power for signal transmission to the wireless base station, and the wireless terminal station receives the comparison result, detects the transmission rate of uplink data to be transmitted to the wireless base station, compares the transmission rate with a preset transmission rate threshold, and, based on the comparison result thereof and the comparison result transmitted from the wireless base station, changes the transmission power variation range for controlling the transmission power. Thus, the amount of interference with other users and with the entire cell can be minimized.

### BRIEF DESCRIPTION OF THE DRAWINGS

FIG. 1 is a diagram showing an exemplary configuration of a conventional wireless base station;

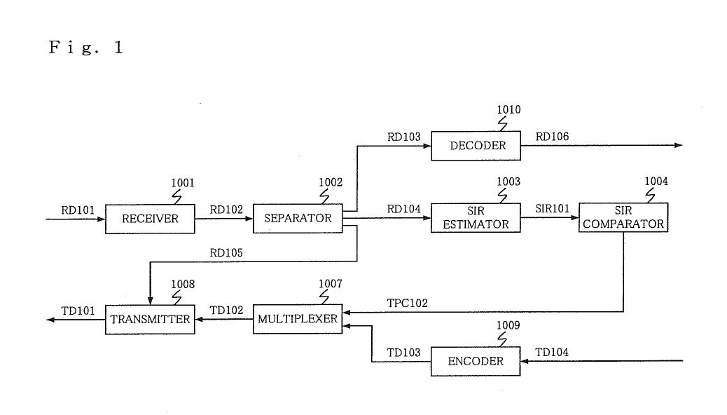

FIG. 2 is a diagram showing the format of a signal received at the conventional wireless base station shown in FIG. 1;

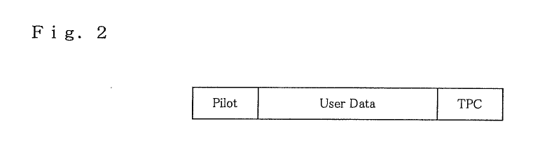

FIG. 3 is a diagram showing the format of a downlink signal transmitted from a wireless base station of the present invention and received at a wireless terminal station of the present invention;

FIG. 4 is a diagram showing the format of an uplink signal transmitted from the wireless terminal station of the present invention and received at the wireless base station of the present invention;

FIG. 5 is a diagram showing an exemplary embodiment of the wireless base station of the present invention;

FIG. 6 is a diagram showing an exemplary embodiment of the wireless terminal station of the present invention;

FIG. 7 is a flowchart for illustrating comparison processing in an SIR comparator shown in FIG. 5;

FIG. 8 is a flowchart for illustrating comparison processing in a frequency estimator shown in FIG. 5;

FIG. 9 is a flowchart for illustrating TPC Command generation processing in a TPC controller shown in FIG. 5;

FIG. 10 is a flowchart for illustrating comparison processing in a transmission rate detector shown in FIG. 6; and

FIG. 11 is a flowchart for illustrating transmission power control step generation processing in the transmission power control step generator shown in FIG. 6.

### BEST MODE FOR CARRYING OUT THE INVENTION

Exemplary embodiments will be described below with reference to the drawings.

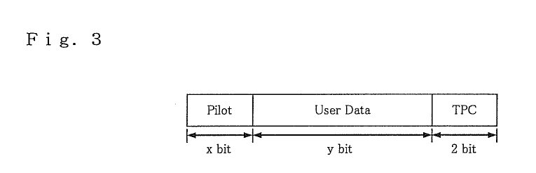

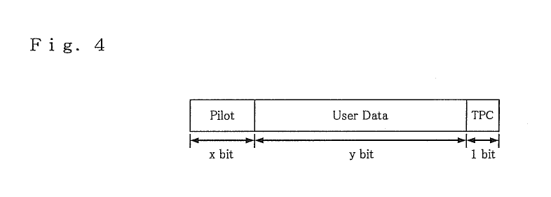

FIG. 3 is a diagram showing a format of a downlink signal transmitted from a wireless base station of the present invention and received at a wireless terminal station of the present invention. FIG. 4 is a diagram showing the format of an uplink signal transmitted from the wireless terminal station of the present invention and received at the wireless base station of the present invention.

As shown in FIG. 3, the downlink signal includes a Pilot signal having x bits, user data having y bits, and a TPC Command having 2 bits.

As shown in FIG. 4, the uplink signal includes a Pilot signal having x bits, user data having y bits, and a TPC Command having 1 bit.

In the present invention, it is assumed that closed-loop transmission power control is performed in both the uplink and downlink directions.

TPC Commands used in the closed-loop transmission power control are mapped into the TPC Command fields shown in FIGS. 3 and 4.

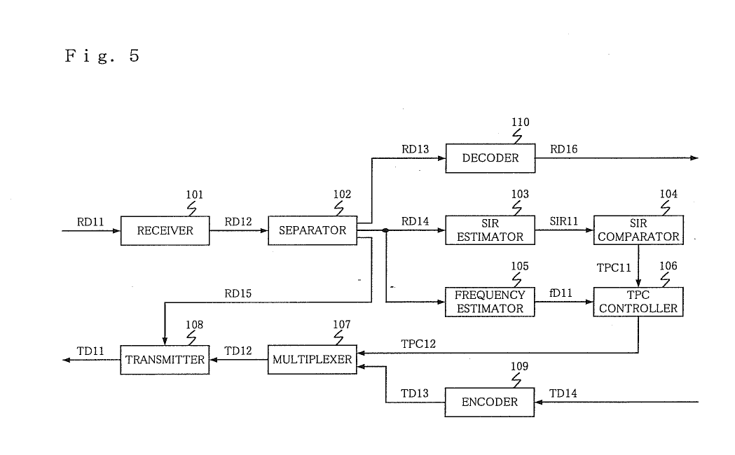

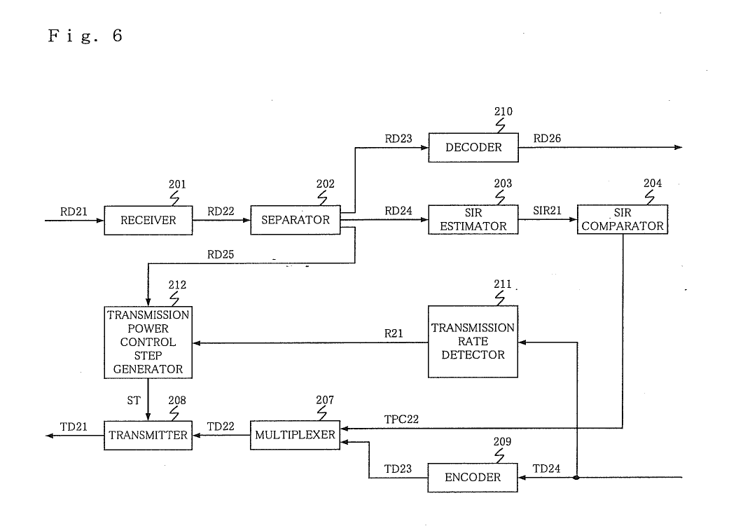

FIG. 5 is a diagram showing an exemplary embodiment of the wireless base station of the present invention, and FIG. 6 is a diagram showing an exemplary embodiment of the wireless terminal station of the present invention.

The wireless base station shown in FIG. 5 is provided with receiver 101, separator 102, SIR estimator 103, SIR comparator 104, frequency estimator 105, TPC controller 106, multiplexer 107, transmitter 108, encoder 109, and decoder 110.

Receiver 101 demodulates received signal RD11 received at the wireless base station into a digital signal in a predetermined scheme and outputs the demodulated signal as RD12 to separator 102. Separator 102 separates input signal RD12 into user data, a Pilot signal, and a TPC Command and outputs them as RD13, RD14, and RD15, respectively: RD13 is output to decoder 110, RD14 is output to SIR estimator 103 and frequency estimator 105, and RD15 is output to transmitter 108. Decoder 110 demodulates RD13 output from separator 102 in a predetermined scheme and transmits the demodulated signal as RD16 to an external data apparatus (not shown). SIR estimator 103 receives input of RD14 output from separator 102, estimates the Reception SIR from input RD14, and outputs the estimated Reception SIR as SIR11 to SIR comparator 104. SIR comparator 104 receives input of SIR11 output from SIR estimator 103, compares input SIR11 with the Target SIR, which is a preset SIR threshold, and outputs the comparison result as TPC11 to TPC controller 106. Frequency estimator 105 estimates the fading frequency from RD14 output from separator 102, compares the estimated fading frequency with a preset frequency threshold, and outputs the comparison result as fD11 to TPC controller 106. TPC controller 106 generates a TPC Command, which is transmission power control information, based on TPC11 output from SIR comparator 104 and fD11 output from frequency estimator 105, and outputs the generated TPC Command as TPC 12 to multiplexer 107. Encoder 109 receives TD14, which is downlink data transmitted from an external data apparatus, encodes TD14 in a predetermined scheme, and outputs it as TD13 to multiplexer 107. Multiplexer 107 receives input of TPC12 output from TPC controller 106 and TD13 output from encoder 109, multiplexes input TPC12 and TD13 into the format shown in FIG. 3, and outputs the multiplexed signal as TD12 to transmitter 108. Here, TD13 is mapped into the user data area shown in FIG. 3, and TD12 is mapped into the TPC Command area shown in FIG. 3. A signal to be mapped into the Pilot signal area shown in FIG. 3 is generated in multiplexer 107. Transmitter 108 converts TD12 output from multiplexer 107 into wireless signal TD11 in a predetermined scheme and transmits the converted signal as TD11 by using transmission power based on RD15 output from separator 102.

The wireless terminal station shown in FIG. 6 is provided with receiver 201, separator 202, SIR estimator 203, SIR comparator 204, multiplexer 207, transmitter 208, encoder 209, decoder 210, transmission rate detector 211, and transmission power control step generator 212.

Receiver 201 demodulates received signal RD21 received at the wireless terminal station into a digital signal in a predetermined scheme and outputs the demodulated signal as RD22 to separator 202. Separator 202 separates input signal RD22 into user data, a Pilot signal, and a TPC Command and outputs them as RD23, RD24, and RD25, respectively: RD23 is output to decoder 210, RD24 is output to SIR estimator 203, and RD25 is output to transmission power control step generator 212. Decoder 210 demodulates RD23 output from separator 202 in a predetermined scheme and transmits the demodulated signal as RD26 to an external data apparatus (not shown). SIR estimator 203 receives input of RD24 output from separator 202, estimates the Reception SIR from input RD24, and outputs the estimated Reception SIR as SIR21 to SIR comparator 204. SIR comparator 204 receives input of SIR21 output from SIR estimator 203, compares input SIR21 with the Target SIR, which is a preset SIR threshold, and outputs the comparison result as TPC22 to multiplexer 207. Encoder 209 receives TD24, which is downlink data transmitted from an external data apparatus, encodes TD24 in a predetermined scheme, and outputs it as TD23 to multiplexer 207. Transmission rate detector 211 detects the transmission rate of TD24, which is uplink data transmitted from the external data apparatus, compares the detected transmission rate with the predetermined transmission rate threshold, and outputs the comparison result as R21 to transmission power control step generator 212. Multiplexer 207 receives input of TPC22 output from SIR comparator 204 and TD23 output from encoder 209, multiplexes input TPC22 and TD23 into the format shown in FIG. 4, and outputs the multiplexed signal as TD22 to transmitter 208. Here, TD23 is mapped into the user data area shown in FIG. 4, and TD22 is mapped into the TPC Command area shown in FIG. 4. A signal to be mapped into the Pilot signal area shown in FIG. 4 is generated in multiplexer 207. Based on RD25 output from separator 202 and R21 output from transmission rate detector 211, transmission power control step generator 212 generates a control step size for controlling the uplink transmission power. The generated control step size is output as ST to transmitter 208. Here, the control step size is the range of variation of transmission power for varying the transmission power. Transmitter 208 converts TD22 output from multiplexer 207 in a predetermined scheme into wireless signal TD21 and transmits the converted signal as TD21 by using transmission power based on ST output from transmission power control step generator 212.

Now, the transmission power control method in the wireless base station shown in FIG. 5 and the wireless terminal station shown in FIG. 6 will be described below.

First, processing in the wireless base station shown in FIG. 5 will be described. Here, processing in SIR comparator 104, frequency estimator 105, and TPC controller 106 that characterizes the present invention will be mainly described. Processing in other components has been described above in the description of the configuration.

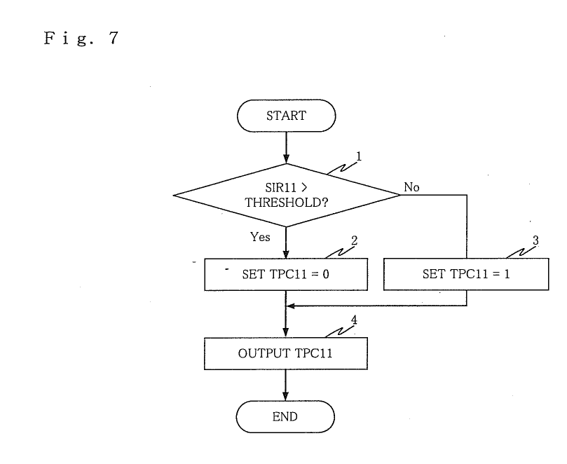

FIG. 7 is a flowchart for illustrating the comparison processing in SIR comparator 104 shown in FIG. 5.

Processing in SIR comparator 104 is similar to conventional processing.

First, when SIR11, which is the Reception SIR value output from SIR estimator 103, is input to SIR comparator 104, it is determined whether SIR11 is larger than the preset Target SIR in step 1.

If SIR11 is larger than the Target SIR, TPC11 is set to “0” in step 2. If SIR11 is not larger than the Target SIR, TPC11 is set to “1” in step 3. Here, TPC11 having the value “0” represents a request that the wireless terminal station should decrease the transmission power used in transmission from the wireless terminal station. TPC11 having the value “1” represents a request that the wireless terminal station should increase the transmission power used in transmission from the wireless terminal station.

TPC11 of the set value is output to TPC controller 106 in step 4.

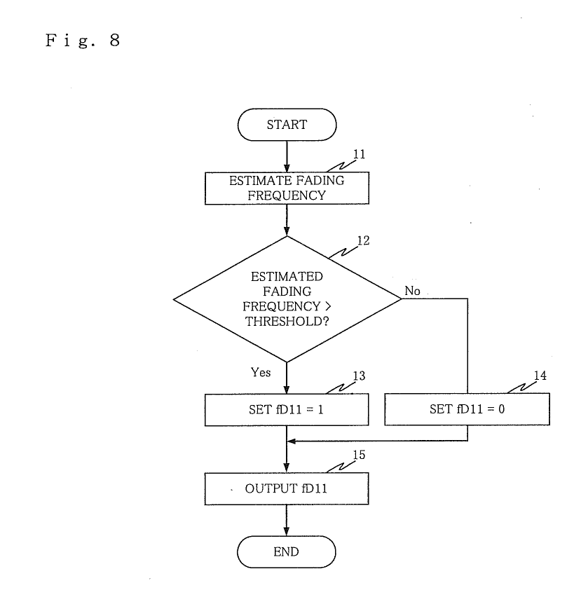

FIG. 8 is a flowchart for illustrating comparison processing in frequency estimator 105 shown in FIG. 5.

When RD14, which is the Pilot signal output from separator 102, is input to frequency estimator 105, the fading frequency is estimated from RD14 in step 11. Here, processing to estimate the fading frequency from the Pilot signal is similar to that of conventional processing.

It is determined whether the estimated fading frequency is larger than the preset frequency threshold in step 12.

If the estimated fading frequency is larger than the frequency threshold, fast fading is identified and fD11 is set to “1” in step 13. If the estimated fading frequency is not larger than the frequency threshold, slow fading is identified and fD11 is set to “0” in step 14.

fD11 of the set value is output to TPC controller 106 in step 15.

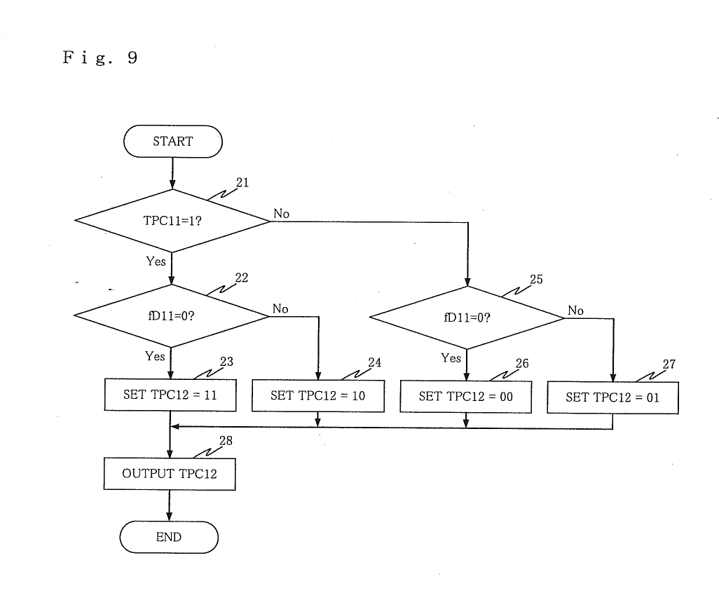

FIG. 9 is a flowchart for illustrating TPC Command generation processing in TPC controller 106 shown in FIG. 5.

First, it is determined whether the value of TPC11 output from SIR comparator 104 and input to TPC controller 106 is “1” in step 21.

If it is determined that the value of TPC11 is “1”, it is determined whether the value of fD11 output from frequency estimator 105 and input to TPC controller 106 is “0” in step 22.

If it is determined that the value of fD11 is “0” in step 22, TPC12 is set to “11” in step 23. If it is determined that the value of fD11 is not “0” in step 22, TPC12 is set to “10” in step 24.

If it is determined that the value of TPC11 is not “1” in step 21, it is determined whether the value of fD11 is “0” in step 25.

If it is determined that the value of fD11 is “0” in step 25, TPC12 is set to “00” in step 26. If it is determined that the value of fD11 is not “0” in step 25, TPC12 is set to “01” in step 27.

TPC12 of the set value is output to multiplexer 107 in step 28.

Thereafter, TPC12 is mapped into the TPC Command area in the format shown in FIG. 3 in multiplexer 107 and transmitted to the wireless terminal station via transmitter 108.

Next, processing in the wireless terminal station shown in FIG. 6 will be described. Here, processing in transmission rate detector 211, transmission power control step generator 212, and transmitter 208 that characterizes the present invention will be mainly described. Processing in other components has been described above in the description of the configuration.

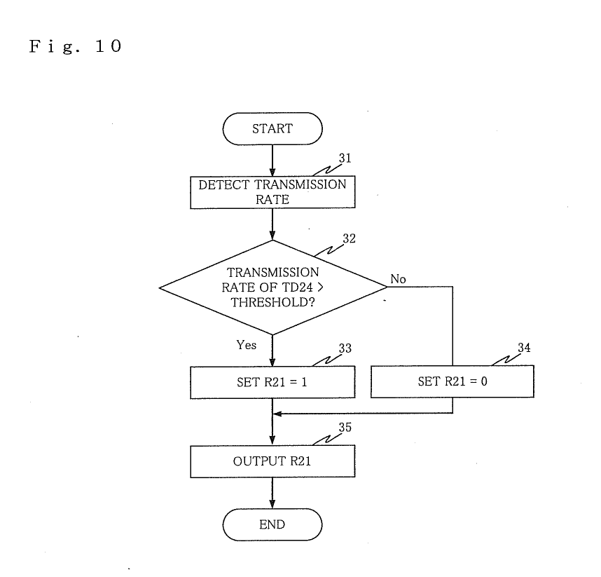

FIG. 10 is a flowchart for illustrating comparison processing in transmission rate detector 211 shown in FIG. 6.

When TD24, which is uplink data transmitted from an external data apparatus, is received in transmission rate detector 211, the transmission rate is detected from TD24 in step 31. Here, processing to detect the transmission rate from the uplink data is similar to that of conventional processing.

It is determined whether the detected transmission rate is larger than the preset transmission rate threshold in step 32.

If the detected transmission rate is larger than the transmission rate threshold, R21 is set to “1”, meaning a fast rate, in step 33. If the detected transmission rate is not larger than the transmission rate threshold, R21 is set to “0”, meaning a slow rate, in step 34. For example, when the transmission rate threshold is set to 64 kbps, R21 is set to “1” if the detected transmission rate is larger than 64 kbps, or is set to “0” if the detected transmission rate is smaller than 64 kbps.

R21 of the set value is output to transmission power control step generator 212 in step 35.

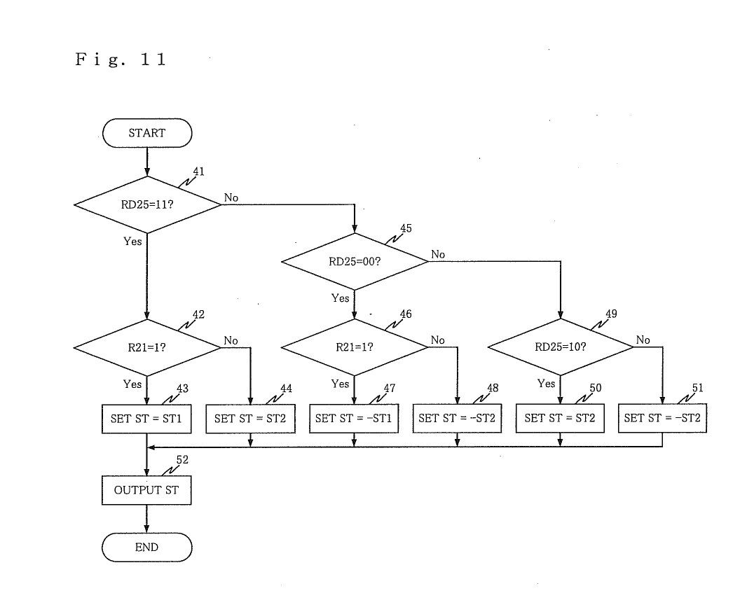

FIG. 11 is a flowchart for illustrating transmission power control step generation processing in transmission power control step generator 212 shown in FIG. 6. Here, RD25 shown in FIG. 6 is equal to TPC12 described in FIG. 9, which has been mapped into the TPC Command area in the format shown in FIG. 3 by multiplexer 107 shown in FIG. 5. That is, RD25 shown in FIG. 6 has the same value as TPC12 shown in FIG. 5.

First, it is determined whether the value of RD25 output from separator 202 and input to transmission power control step generator 212 is “11” in step 41.

If it is determined that the value of RD25 is “11”, it is determined whether the value of R21 output from transmission rate detector 211 and input to transmission power control step generator 212 is “1” in step 42.

If it is determined that the value of R21 is “1” in step 42, ST is set to ST1 in step 43. If it is determined that the value of R21 is not “1” in step 42, ST is set to ST2 in step 44. Here, ST1 and ST2 are preset transmission power control step sizes, and ST1 is the control step size that allows compensation for wireless-signal attenuation due to slow fading. The relationship between the magnitude of ST1 and ST2 is ST1>ST2, such that ST1=1 dB, and ST2=0.5 dB, for example.

If it is determined that the value of RD25 is not “11” in step 41, it is further determined whether the value of RD25 is “00” in step 45.

If it is determined that the value of RD25 is “00” in step 45, it is determined whether the value of R21 is “1” in step 46.

If it is determined that the value of R21 is “1” in step 46, ST is set to −ST1 in step 47. If it is determined that the value of R21 is not “1” in step 46, ST is set to −ST2 in step 48.

If it is determined that the value of RD25 is not “00” in step 45, it is further determined whether the value of RD25 is “10” in step 49.

If it is determined that the value of R25 is “10” in step 49, ST is set to ST2 in step 50. If it is determined that the value of R25 is not “10” in step 49, ST is set to −ST2 in step 51.

ST of the set value is output to transmitter 208 in step 52.

When ST output from transmission power control step generator 212 is input to transmitter 208, transmission power control based on ST is performed in transmitter 208. For example, if the previous transmission power is P(n−1), the transmission power P(n) will be P(n−1)+ST. Here, while this ST has conventionally been a fixed value, it is variable in the present invention as described above. This allows the step size of the transmission power control to be controlled based on the fading frequency and the transmission rate. The step size of the transmission power control is set larger in the case of slow fading and fast-rate transmission data, and smaller otherwise.

Although the control step size is set to two sizes, i.e., ST1 and ST2 in the above-described example, the control step size may be set to the number of sizes other than two.

Generally, if the control step size of the uplink transmission power control is small, unnecessary ups and downs of the transmission power are reduced when the Reception SIR matches the Target SIR. It also leads to a reduction in the amount of interference in the entire cell because the amount of interference with other users due to transmission power control will be small.

However, setting a small control step size for the transmission power slows the speed in following the Target SIR, so that fluctuations in a wireless line due to fading cannot be followed. This involves a risk of degradation in the reception quality.

To avoid this, the above-described processing is used to set a large control step size for the uplink transmission power control in the case of slow fading and fast rate, and a small control step size otherwise. Thus, an increase in the amount of interference and degradation in the reception quality can be minimized.

For only fast-rate wireless terminal stations that are in increasing demand these days, the control step size of the uplink transmission power can be set large, and for other wireless terminal stations, the control step size of the uplink transmission power can be set small. In this manner, an increase in transmission power due to interference among users can be minimized.

In the light of the above, the control step size of the uplink transmission power, in the present invention, is variable depending on the transmission rate of external data that is input to the wireless terminal station. For example, when data communication is performed generally at a slow rate and performed at a fast rate only for significant data, as in packet communication, a large control step size can be set only for the fast-rate communication.

Thus, since different control step sizes can be used in the same wireless terminal station depending on the amount of data being transmitted, increasing the control step size can be minimized. This is effective for preventing an increase in the amount of interference in the entire cell.

Even when there is a rapid increase in uplink transmission power in a certain wireless terminal station, the amount of increase in the uplink transmission power is small because the control step size for wireless terminal stations that are undergoing fast fading or a slow rate is small. Therefore, a rapid change in the amount of interference in the entire cell can be prevented.

In the closed loop, compensation for uplink-signal attenuation due to fast fading is temporally impossible. Therefore, in the present invention, control is purposely optimized for slow fading, and on the other hand, a small control step size is set for fast fading. This aims to minimize interference with other users by restraining the transmission power fluctuations caused in an attempt to follow fast fading, and by setting a large control step size only in the case of slow fading that allows compensation for the amount of attenuation even in the closed loop.

What is claimed:

1. A wireless communication system comprising a wireless base station and a wireless terminal station that transmits a signal to the wireless base station, the wireless terminal station controlling transmission power for signal transmission to the wireless base station, characterized in that
the wireless base station estimates a fading frequency of a signal transmitted from the wireless terminal station and received, compares the estimated fading frequency with a preset frequency threshold, and transmits a comparison result to the wireless terminal station, and
the wireless terminal station receives the comparison result, detects a transmission rate of uplink data to be transmitted to the wireless base station, compares the transmission rate with a preset transmission rate threshold, and, based on a comparison result thereof and the comparison result transmitted from the wireless base station, changes a transmission power variation range for controlling the transmission power.

2. The wireless communication system according to claim 1, characterized in that
the wireless base station comprises frequency estimation means for estimating the fading frequency of the signal transmitted from the wireless terminal station and received and comparing the estimated fading frequency with the preset frequency threshold, and
the wireless terminal station comprises:
transmission rate detection means for detecting the transmission rate of the uplink data to be transmitted to the wireless base station and comparing the transmission rate with the preset transmission rate threshold; and
transmission power control step generation means for changing, based on the comparison result in the transmission rate detection means and the comparison result in the frequency estimation means, the transmission power variation range for controlling the transmission power.

3. The wireless communication system according to claim 2, characterized in that
if the transmission rate is larger than the transmission rate threshold and if the comparison result in the frequency estimation means indicates that the fading frequency is smaller than the frequency threshold, the transmission power control step generation means increases the transmission power variation range for controlling the transmission power.

4. (canceled)

5. A wireless terminal station connected to a wireless base station, the wireless terminal station receiving transmission power control information transmitted from the wireless base station and, based on the received transmission power control information, controlling transmission power for signal transmission to the wireless base station, wherein
the wireless terminal station detects a transmission rate of uplink data to be transmitted to the wireless base station, compares the transmission rate with a preset transmission rate threshold, and, based on a comparison result and the transmission power control information, changes a transmission power variation range for controlling the transmission power.

6. The wireless terminal station according to claim 5, characterized by comprising:
transmission rate detection means for comparing the transmission rate of the uplink data to be transmitted to the wireless base station with the preset transmission rate threshold; and
transmission power control step generation means for changing, based on the comparison result in the transmission rate detection means and the transmission power control information, the transmission power variation range for controlling the transmission power.

7. A transmission power control method in a wireless communication system comprising a wireless base station and a wireless terminal station that transmits a signal to the wireless base station, the wireless terminal station controlling transmission power for signal transmission to the wireless base station, comprising:
the wireless base station estimating a fading frequency of a signal transmitted from the wireless terminal station and received;
the wireless base station comparing the estimated fading frequency with a preset frequency threshold;
the wireless base station transmitting a comparison result to the wireless terminal station;
the wireless terminal station detecting a transmission rate of uplink data to be transmitted to the wireless base station;
the wireless terminal station comparing the transmission rate with a preset transmission rate threshold; and
the wireless terminal station changing, based on a comparison result thereof and the comparison result transmitted from the wireless base station, a transmission power variation range for controlling the transmission power.

8. The transmission power control method according to claim 7, characterized by comprising
increasing the transmission power variation range for controlling the transmission power if the transmission rate is larger than the transmission rate threshold and if the fading frequency is smaller than the frequency threshold.
